(19) United States
(12) Patent Application Publication
(10) Pub. No.: US 2019/0104388 A1
(43) Pub. Date: Apr. 4, 2019

(54) Managing A Scan List For A User Device By A Privileged User

(71) Applicant: MOTOROLA SOLUTIONS, INC, CHICAGO, IL (US)

(72) Inventors: MADHUSUDAN PAI, PALATINE, IL (US); VAIDYANATH CHANDRAMOWLEESWARAN, PALATINE, IL (US); RITESH DESAI, ALGONQUIN, IL (US); VIRAT G. PATEL, DES PLAINES, IL (US)

(21) Appl. No.: 15/723,964

(22) Filed: Oct. 3, 2017

(51) Int. Cl. H04W 4/08; H04W 4/10

(52) U.S. Cl. CPC H04W 4/08; H04W 4/10

(57) ABSTRACT

A method and console are provided that create an explicit talk group list for a user device, the explicit talk group list is created by the user device and includes a plurality of first talk groups. A privileged user device, such as a console, creates an implicit talk group list for the user device. The implicit talk group list includes a plurality of second talk groups. The explicit talk group is combined with the implicit talk group list to form a scan list. If the number of talk groups in the scan list exceeds a predetermined threshold, enough talk groups are removed from the scan list until the number of talk groups in the talk group equals the predetermined threshold.

### BACKGROUND OF THE INVENTION

There are times when a privileged user, such as a console or administrative user, desires to remotely assign a talk group to a user device as either an active talk group or as a monitored talk group.

When a user of a user device selects an active talk group, that talk group is actively monitored by the user device. However, if a privileged user assigns a talk group to the user device, this talk group will be monitored by the user device. This can lead to confusion for the user of the user device.

In addition, if there are multiple privileged users, there could be multiple active talk groups assigned to the user device. Currently there is no way to arbitrate which of the talk groups assigned by privileged users should become active if multiple talk groups are assigned to a user device.

Therefore a need exists for a way of determining which talk group should be active for a user of a user device. In addition, if there are multiple privileged users, there could be multiple monitored talk groups assigned to the user device. Currently there is no way to arbitrate which of the talk groups assigned by privileged users should become monitored talk groups if multiple talk groups are assigned to a user device. Therefore a need exists for a way of determining which talk groups should be monitored by a user of a user device.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 depicts a system diagram of a portion of a communication system in accordance with an exemplary embodiment of the present invention.

FIG. 2 depicts a call flow diagram in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

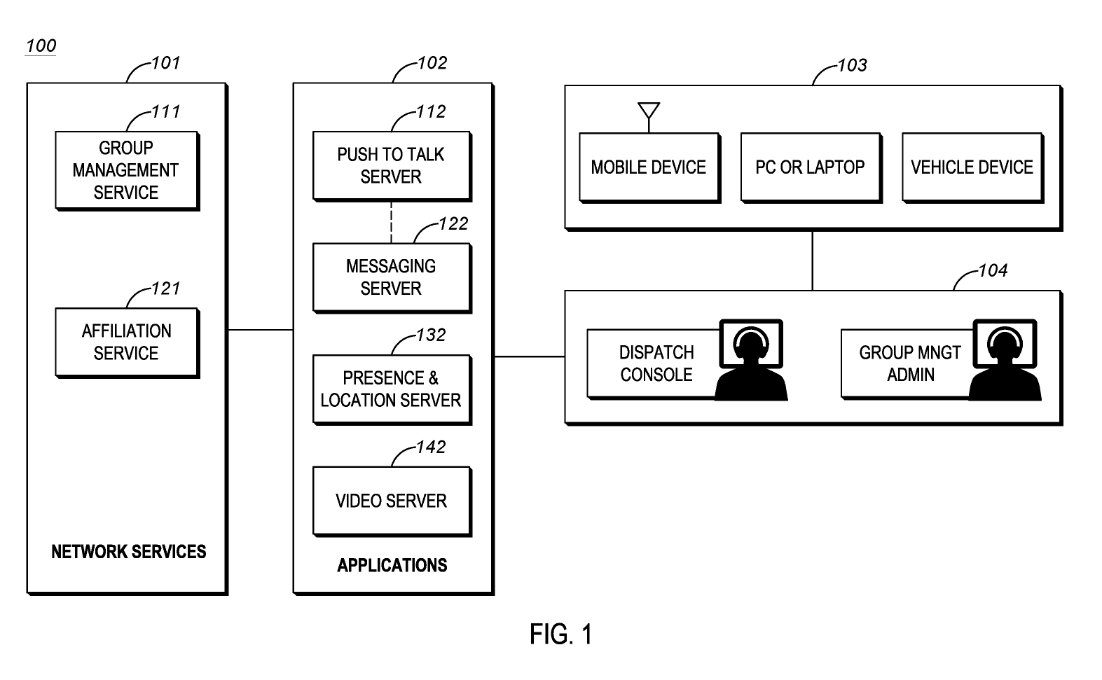

FIG. 1 depicts a system diagram of a portion of a communication system 100 in accordance with an exemplary embodiment of the present invention.

In an exemplary embodiment, communications system 100 provides voice services, including push to talk along with data services such as messaging, mapping, presence, and location. Communication system 100 comprises network services 101, such as a group management service 111 and an affiliation service 121 among other services. Group management service 111 preferably manages the assignment of groups to users.

Affiliation service 121 preferably manages the set of users currently monitoring the groups in the system. For example, group management service 111 may make a group available to thousands of users whereas affiliation service 121 may manage the hundred users currently affiliated to the group and interested in communication events on that group.

Network applications 102 include voice applications such as push to talk server 112 and data applications such as video server 142, messaging server 122, and presence and location server 132, for providing mapping services. In an exemplary embodiment, these applications may target communication events to users assigned the group or a subset of users affiliated to the group.

Privileged user devices 104, such as dispatch console operators and contact/group management administrators, control user assignment to groups and users affiliated to groups. These privileged users are also enabled to assign groups as active or monitored to the user devices for one or more voice applications and/or data applications.

User devices 103 receive group list and affiliation updates on devices including mobile handsets, fixed computing devices and vehicle devices. The information preferably includes active and monitored talk group assignments for one or more voice applications and/or data applications.

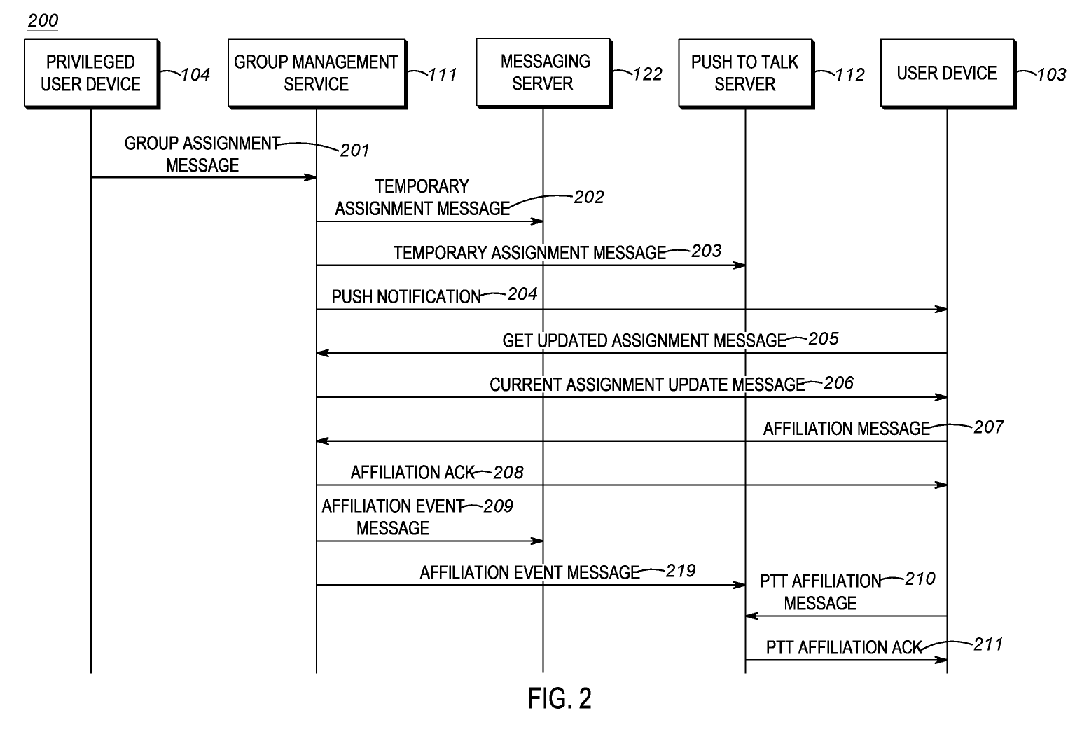

FIG. 2 depicts a call flow diagram 200 in accordance with an exemplary embodiment of the present invention. In this exemplary embodiment, a privileged user, such as a console or Agency Contact/Group Administrator, controls the affiliation capabilities of a user of a user device with respect to talk group scan list assignments.

To begin the process, a privileged user utilizes privileged user device 104 to send a Group Assignment Message 201 to Group Management Service 111. Group Assignment Message 201 preferably assigns a group as an active group to a first set of user devices and/or as monitored to a second set of user devices. The assignment of the group to user device 103 may be for one or more voice applications and/or data applications.

Group Management Service 111 sends Temporary Assignment Message 202 to Messaging Server 122.

Group Management Service 111 sends Temporary Assignment Message 203 to Push to Talk Server 112.

Group Management Service 111 sends Push Notification 204 to user device 103, which preferably informing user device 103 of an update.

User device 103 sends Get Updated Assignment Message 205 to Group Management Service 111.

Group Management Service 111 sends Current Assignment Update Message 206 to user device 103. Current Assignment Update Message 206 includes the group list updates with information of active or monitored talk group assignment and the services available to user device 103 for each assigned group.

User device 103 expresses interest to participate in communication events on the group by sending Affiliation Message 207 to Group Management Service 111.

Group Management Service 111 sends Affiliation Ack 208 to user device 103.

Group Management Service 111 sends Affiliation Event Message 209 to Messaging Server 122.

Group Management Service 111 sends Affiliation Event Message 219 to Push To Talk Server 112.

In accordance with an exemplary embodiment, user device 103 directly sends PTT Affiliation Message 210 to PTT Server 112.

PTT Server 112 sends PTT Affiliation Ack 211 to user device 103.

User device 103 now preferably changes its selected talkgroup to the newly assigned active talk group.

In another exemplary embodiment, if a first privileged user assigned a first group as the active group to a user device and a second privileged user later assigns a second group as the active group to that user device, the active group is set to either the first group or the second group based on factors such as priority of the privileged user that assigned the group, attributes of the assigned group (such as priority, association with an incident, type of group, user's privileges for the group, etc), chronological sequence of events (e.g. first in wins or last in wins), etc. This arbitration may be made at any of: the user device, the privileged user device or a network device such as the Group management and Affiliation service.

In yet another exemplary embodiment, if a first privileged user assigned a first group as the active group to a user device and a second privileged user later assigned a second group as the active group to a user device and later the second group was unassigned from the user device, the first group is set as the active group of the user device. This arbitration may be made at any of: the user device, the privileged user device or a network device such as the Group management and Affiliation service.

In yet another exemplary embodiment, if one or more privileged users assigned one or more monitored groups to the user device, the list of monitored groups of the user device is determined based on factors such as priority of the privileged user that assigned the group, attributes of the assigned group (such as priority, association with an incident, type of group, user's privileges for the group, etc), chronological sequence of events (e.g. first in wins or last in wins), etc. This arbitration may be made at any of: the user device, the privileged user device or a network device such as the Group management and Affiliation service.

In yet another exemplary embodiment, if a user has selected a scan list of groups to monitor on the user device which contains a given group and the same group is now assigned by a privileged user as active or monitored to the user device, the group is monitored by the user device for the duration of the assignment, independent of the user choosing a different scan list and/or disabling the scan functionality at the user device. In yet another exemplary embodiment of this scenario, the same outcome is reached if the privileged user assigns the group before the user chooses to add the same group to the user's scan list. In yet another exemplary embodiment of this scenario, if the user removes such a group from the user's scan list, the user device stops monitoring the group once the privileged user removes the group assignment.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
creating an explicit talk group list for a user device, the explicit talk group list created by the user device and comprising a plurality of first talk groups;
creating an implicit talk group list for the user device, the implicit talk group list created by a privileged user device coupled with the user device and comprising a plurality of second talk groups; and
selecting an active talk group for the user device from one of the plurality of first talk groups or one of the plurality of second talk groups.

2. The method of claim 1, the method further comprising the step of moving one of the plurality of first talk groups from the explicit talk group list to the implicit talk group list.

3. The method of claim 2, wherein the step of moving one of the plurality of first talk groups from the explicit talk group list to the implicit talk group list comprises moving one of the plurality of first talk groups from the explicit talk group list to the implicit talk group list if the one of the plurality of first talk groups is available to the user device.

4. The method of claim 2, wherein the step of moving one of the plurality of first talk groups from the explicit talk group list to the implicit talk group list comprises moving one of the plurality of first talk groups from the explicit talk group list to the implicit talk group list if the one of the plurality of first talk groups is on a scan list of the user device.

5. The method of claim 1, the method further comprising the step of moving one of the plurality of second talk groups from the implicit talk group list to the explicit talk group list.

6. The method of claim 5, wherein the step of moving one of the plurality of second talk groups from the implicit talk group list to the explicit talk group list comprises moving one of the plurality of second talk groups from the implicit talk group list to the explicit talk group list if the one of the plurality of second talk groups is available to the user device.

7. The method of claim 5, wherein the step of moving one of the plurality of second talk groups from the implicit talk group list to the explicit talk group list comprises moving one of the plurality of second talk groups from the implicit talk group list to the explicit talk group list if the one of the plurality of second talk groups is on a scan list of the user device.

8. The method of claim 1, wherein the step of creating an implicit talk group list for the user device comprises creating an implicit talk group list for the user device that lasts for a predetermined period of time.

9. The method of claim 1, the method further comprising the step of removing, by the privileged user device, the active talk group for the user device.

10. The method of claim 9, the method further comprising the step of selecting, by the privileged user device, a second active talk group for the user device from one of the plurality of first talk groups or one of the plurality of second talk groups.

11. The method of claim 10, wherein the second active talk group is selected based at least in part upon the last talk group selected by the user device.

12. The method of claim 10, wherein the second active talk group is selected based at least in part upon the last talk group assigned by the privileged user device.

13. The method of claim 1, the method further comprising the step of selecting a second active talk group for the user device by the user device from one of the plurality of first talk groups or one of the plurality of second talk groups.

14. The method of claim 13, the method further comprising the step of providing, by the user device, a notification that the second active talk group is not one of the plurality of second talk groups.

15. The method of claim 1, wherein the step of selecting an active talk group for the user device comprises selecting an active talk group for the user device by the privileged user device.

16. The method of claim 1, wherein the step of selecting an active talk group for the user device comprises selecting an active talk group for the user device by a network device.

17. The method of claim 1, wherein the step of selecting an active talk group for the user device comprises selecting an active talk group for the user device by the user device.

18. A method comprising:
creating an explicit talk group list for a user device, the explicit talk group list created by the user device and comprising a plurality of first talk groups;
creating an implicit talk group list for the user device, the implicit talk group list created by a privileged user device coupled with the user device and comprising a plurality of second talk groups;
combining the explicit talk group with the implicit talk group to form a scan list; and
removing, if the number of talk groups in the scan list exceeds a predetermined threshold, talk groups from the scan list until the number of talk groups in the scan list equals the predetermined threshold.

19. The method of claim 18, wherein the step of creating an implicit talk group list for the user device comprises creating an implicit talk group list for the user device that lasts for a predetermined period of time.

20. A privileged user device comprising a processor configured to:
create an explicit talk group list for a user device, the explicit talk group list created by the user device and comprising a plurality of first talk groups;
create an implicit talk group list for the user device, the implicit talk group list created by a privileged user coupled with the user device and comprising a plurality of second talk groups;
combine the explicit talk group with the implicit talk group to form a scan list; and
remove, if the number of talk groups in the scan list exceeds a predetermined threshold, talk groups from the scan list until the number of talk groups in the scan list equals the predetermined threshold.
